(19) United States
(12) Patent Application Publication
(10) Pub. No.: US 2021/0070279 A1
(43) Pub. Date: Mar. 11, 2021

(54) VEHICLE CONTROL UNIT

(71) Applicant: HONDA MOTOR CO., LTD., Tokyo (JP)

(72) Inventors: Naoki YUI, Saitama (JP); Yosuke NAITO, Saitama (JP); Ken HAYASAKA, Saitama (JP)

(73) Assignee: HONDA MOTOR CO., LTD., Tokyo (JP)

(21) Appl. No.: 17/012,738

(22) Filed: Sep. 4, 2020

(30) Foreign Application Priority Data
Sep. 6, 2019 (JP) 2019-163181

(51) Int. Cl. B60W 20/15; B60W 20/40; B60W 20/13; B60W 50/08

(52) U.S. Cl. CPC B60W 20/15; B60W 20/40; B60W 2510/085; B60W 50/082; B60W 2510/246; B60W 20/13

(57) ABSTRACT

A control unit of a vehicle, which is configure to travel in a first traveling mode in which power outputted from an electric motor according to electric power supplied from a generator and an electric storage device is used and in a second traveling mode in which power outputted from an internal combustion engine and the electric motor according to the electric power supplied from the electric storage device is used, includes: a vehicle speed acquisition unit; a driving force acquisition unit configured to acquire a driving force in the first traveling mode according to a vehicle speed and a driving force in the second traveling mode according to the vehicle speed; and a traveling mode control unit configured to drive the vehicle in the traveling mode capable of obtaining a large driving force at the vehicle speed based on a comparison result of the driving forces.

### CROSS-REFERENCE TO RELATED APPLICATIONS

The present application claims the benefit of priority of Japanese Patent Application No. 2019-163181, filed on Sep. 6, 2019, the content of which is incorporated herein by reference.

### TECHNICAL FIELD

The present invention relates to a vehicle control unit.

### BACKGROUND ART

In recent years, a hybrid electric vehicle including an internal combustion engine and an electric motor has been developed. Hybrid electric vehicles are roughly classified into two types: series type and parallel type. A series-type hybrid electric vehicle is driven by the power of an internal combustion engine, which causes a generator to generate power, which supplies electric power generated by the generator to an electric motor, and the power of the electric motor drives a drive wheel. On the contrary, a parallel-type hybrid electric vehicle is driven by driving a drive wheel with the power of at least one of an internal combustion engine and an electric motor. A hybrid electric vehicle capable of switching between those two types is also known. In the hybrid electric vehicle, a power transmission type is switched to either a series type or a parallel type by releasing or engaging (that is, connecting or disconnecting) a clutch according to a traveling state.

Japanese Patent No. 5720893 describes a technique in which the series mode and the parallel mode are switched at a vehicle speed at which the maximum torque that can be generated in the series mode and the maximum torque that can be generated in the parallel mode match.

In Japanese Patent No. 5201190, a technique is described in which the smaller of a first available battery output obtained from a battery output map for the battery charging rate and a second available battery output obtained from a battery output map for the battery temperature is obtained as the available battery output for the battery and, when it becomes the vehicle speed (changed vehicle speed) set according to the available battery output, a state of the clutch is changed from a coupled state to a released state to change a driving state from an engine driving state to a motor driving state.

However, the above-described maximum torque, available battery output, and the like may change depending on factors such as the surrounding environment of the vehicle and the battery temperature. Therefore, it is desired to select an appropriate driving mode according to such a change in the situation and drive the vehicle in the driving mode. When an appropriate driving mode cannot be selected and a driving force of the vehicle is reduced by shifting the driving mode, so-called “stuttering” may occur, which may lead to deterioration of the quality of the vehicle.

### SUMMARY

The present invention provides a vehicle which allows a vehicle to travel in an appropriate driving mode according to changes in a situation and prevents a decrease in a driving force.

According to an aspect of the present invention, there is provided a control unit of a vehicle, which includes: an internal combustion engine; a generator configured to generate electric power by power of the internal combustion engine; an electric storage device configured to store the electric power generated by the generator; an electric motor configured to output power according to the electric power supplied from the generator or the electric storage device and drive a drive wheel; and a connecting-disconnecting portion configured to connect and disconnect a power transmission path between the internal combustion engine and the drive wheel, and which is configure to travel in a plurality of traveling mode including: a first traveling mode in which the connecting-disconnecting portion is disconnected and the drive wheel is driven by the power output from the electric motor according to the electric power supplied from the generator and the electric storage device; and a second traveling mode in which the connecting-disconnecting portion is connected and the drive wheel is driven by the power output from the internal combustion engine and the power output from the electric motor according to the electric power supplied from the electric storage device, the control unit including: a vehicle speed acquisition unit configured to acquire a vehicle speed of the vehicle; a driving force acquisition unit configured to acquire a driving force in the first traveling mode according to the vehicle speed and a driving force in the second traveling mode according to the vehicle speed; and a traveling mode control unit configured to drive the vehicle in the traveling mode capable of obtaining a large driving force at the vehicle speed based on a comparison result of the driving force in the first traveling mode according to the vehicle speed and the driving force in the second traveling mode according to the vehicle speed.

According to the aspect of the present invention, based on the comparison result of the driving force in the first traveling mode corresponding to the actual vehicle speed of the vehicle and the driving force in the second traveling mode corresponding to the actual vehicle speed, the vehicle is driven in the driving mode in which a large driving force can be obtained at the actual vehicle speed. Therefore, the vehicle can be driven in an appropriate traveling mode according to changes in the situation, and thus a decrease in the driving force can be prevented.

### BRIEF DESCRIPTION OF THE DRAWINGS

FIG. 1 is a block diagram illustrating an internal configuration of a hybrid electric vehicle (vehicle) capable of switching a type between a series type and a parallel type;

FIG. 2A is a diagram illustrating transmission of power and electric power in a first hybrid drive mode;

FIG. 2B is a diagram illustrating the transmission of the power and the electric power in a second hybrid drive mode;

FIG. 3A is a diagram illustrating the transmission of the power and the electric power in a first engine drive mode;

FIG. 3B is a diagram illustrating the transmission of the power and the electric power in a second engine drive mode;

FIG. 4 is a diagram illustrating the transmission of the power and the electric power in an EV mode;

FIG. 5 is a block diagram illustrating an internal configuration of a control unit which controls a traveling mode;

FIG. 6 is a diagram illustrating an example of a map showing a relationship between a vehicle speed, a motor temperature, and a driving force in each traveling mode;

FIG. 7 is a diagram illustrating an example of a map showing a relationship between the vehicle speed, an atmospheric pressure, and the driving force in each traveling mode;

FIG. 8 is a diagram illustrating an example of a map showing a relationship between the vehicle speed, SOC, and the driving force in each traveling mode;

FIG. 9 is a diagram illustrating an example of a map showing a relationship between the vehicle speed, a battery temperature, and the driving force in each traveling mode;

FIG. 10A is a diagram illustrating an example in which a stepwise change in driving force occurs with shift from the hybrid drive mode to the engine drive mode;

FIG. 10B is a diagram illustrating a first example of prohibition and permission for shifting a mode to the engine drive mode;

FIG. 11A is a diagram illustrating another example in which a stepwise change in driving force occurs with the shift from the hybrid drive mode to the engine drive mode; and

FIG. 11B is a diagram illustrating a second example of prohibition and permission of shifting to the engine drive mode.

### DESCRIPTION OF EMBODIMENTS

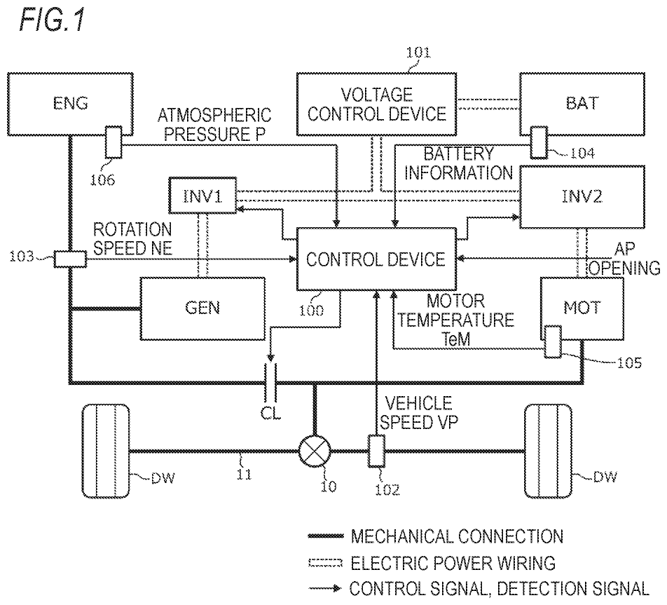

Hereinafter, an embodiment of the present invention will be described with reference to the drawings. As illustrated in FIG. 1, a hybrid electric vehicle (hereinafter simply referred to as “vehicle”) of the embodiment includes an engine ENG, a generator GEN, a motor MOT, a first inverter INV1, a second inverter INV2, a battery BAT, a lockup clutch (hereinafter, simply referred to as “clutch”) CL, a control unit (electronic control unit (ECU)) 100, a voltage control unit (VCU) 101, a vehicle speed sensor 102, a rotation speed sensor 103, a battery sensor 104, a motor temperature sensor 105, and an atmospheric pressure sensor 106. In FIG. 1, thick solid lines indicate mechanical connection, double dotted lines indicate electric power wiring, and thin solid line arrows indicate control signals or detection signals.

The engine ENG drives the generator GEN in a state where the clutch CL is disengaged. On the other hand, when the clutch CL is engaged, the power output from the engine ENG is transmitted to drive wheels DW and DW as mechanical energy for the vehicle to travel through the clutch CL, a gear box (not illustrated), a differential gear 10, a drive shaft 11, and the like. Here, the gearbox includes a gear stage or a fixed stage, and the power from the engine ENG is geared at a predetermined gear ratio and transmitted to the drive wheel DW. The gear ratio in the gearbox is changed according to an instruction from the control device 100.

The generator GEN is driven by the power of the engine ENG to generate electric power. The generator GEN can operate as an electric motor when braking the vehicle.

The motor MOT operates as an electric motor by receiving electric power from at least one of the battery BAT and the generator GEN, and generates power for running the vehicle. The power generated by the motor MOT is transmitted to the drive wheels DW and DW via the differential gear 10 and the drive shaft 11. The motor MOT can operate as a generator when the vehicle is braked.

The clutch CL disengages or engages (disconnects or connects) the power transmission path from the engine ENG to the drive wheels DW and DW according to an instruction from the control device 100. When the clutch CL is in the disengaged state, the power output from the engine ENG is not transmitted to the drive wheels DW and DW. When the clutch CL is in the connected state, the power output from the engine ENG is transmitted to the drive wheels DW and DW.

The battery BAT has a plurality of storage cells connected in series and supplies a high voltage of 100 V to 200 V, for example. The power storage cell is, for example, a lithium ion battery or a nickel hydrogen battery.

The voltage control device 101 boosts the output voltage of the battery BAT when the motor MOT operates as an electric motor. The voltage control device 101 steps down the output voltage of the motor MOT when charging the battery BAT with the regenerative electric power generated by the motor MOT and converted into DC during braking of the vehicle. The voltage control device 101 steps down the electric power generated by the generator GEN by driving the engine ENG and converted into direct current. The electric power stepped down by the voltage control device 101 is charged in the battery BAT.

The vehicle speed sensor 102 detects the traveling speed (vehicle speed VP) of the vehicle. The vehicle speed VP linearly corresponds to the rotation speed of the drive wheels DW and DW. A signal indicating the vehicle speed VP detected by the vehicle speed sensor 102 is sent to the control unit 100. The rotation speed sensor 103 detects a rotation speed NE of the engine ENG. A signal indicating the rotation speed NE detected by the rotation speed sensor 103 is sent to the control unit 100.

The battery sensor 104 has a battery output sensor which detects the output (terminal voltage, charging/discharging current) of the battery BAT and a battery temperature sensor which detects a temperature TeB of the battery BAT. A signal indicating the terminal voltage or charge/discharge current detected by the battery output sensor and information indicating the temperature TeB detected by the battery temperature sensor are sent to the control unit 100 as battery information.

The motor temperature sensor 105 detects a temperature TeM of the motor MOT. A signal indicating the temperature TeM detected by the motor temperature sensor 105 is sent to the control unit 100. The atmospheric pressure sensor 106 detects an atmospheric pressure P around the vehicle. A signal indicating the atmospheric pressure P detected by the atmospheric pressure sensor 106 is sent to the control unit 100.

The control unit 100 performs drive control of the engine ENG, output control of the generator GEN by control of the first inverter INV1, connection/disconnection control of the clutch CL, and output control of the motor MOT by control of the second inverter INV2.

The control unit 100 receives a signal indicating an accelerator pedal opening (AP opening) according to an accelerator pedal operation by a driver of the vehicle, a signal indicating the vehicle speed VP from the vehicle speed sensor 102, a signal indicating the rotation speed NE of the engine ENG from the rotation speed sensor 103, batter information from the battery sensor 104, a signal indicating the temperature TeM from the motor temperature sensor 105, a signal indicating the atmospheric pressure P from the atmospheric pressure sensor 106, and the like. The control unit 100 controls the state of the clutch CL and the outputs of the engine ENG, the generator GEN, and the motor MOT based on those signals and information to control the traveling mode of the vehicle.

[Traveling Modes of Vehicle]

Next, the traveling modes of the vehicle of the embodiment will be described. The vehicle can travel in “first hybrid drive mode”, “second hybrid drive mode”. “first engine drive mode”, “second engine drive mode”, and “EV mode” and the vehicle travels in one of those travel modes.

Hereinafter, the first hybrid drive mode and the second hybrid drive mode may be collectively referred to simply as “hybrid drive mode”. Hereinafter, the first engine drive mode and the second engine drive mode may be collectively referred to simply as “engine drive mode”.

[Hybrid Drive Mode]

The hybrid drive mode is a traveling mode in which electric power generated by the generator GEN by the power of the engine ENG is supplied to the motor MOT and the power output by the motor MOT according to the electric power is mainly used.

[First Hybrid Drive Mode]

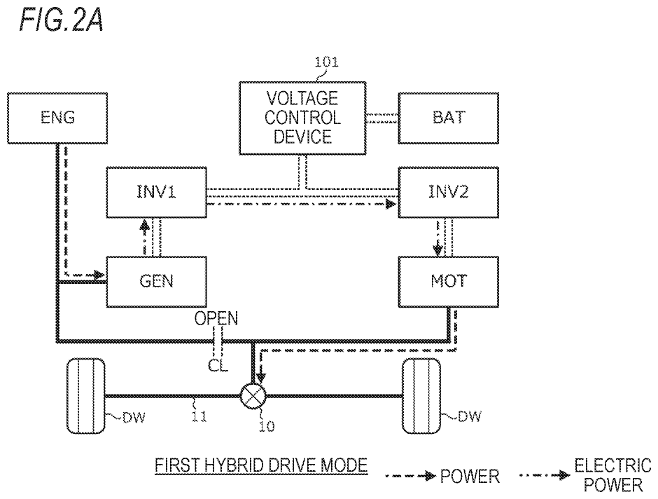

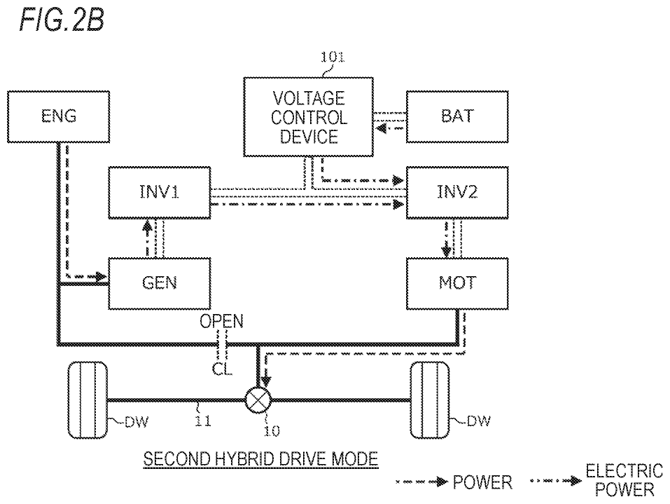

As illustrated in FIG. 2A, in the first hybrid drive mode, the clutch CL is released (that is, brought into a disconnected state). Then, the electric power generated by the generator GEN by the power of the engine ENG is supplied to the motor MOT and the drive wheels DW and DW are driven by the power output by the motor MOT according to the electric power to travel the vehicle.

[Second Hybrid Drive Mode]

The second hybrid drive mode is different from the first hybrid drive mode in that the electric power from the battery BAT is also supplied to the motor MOT. That is, as illustrated in FIG. 2B, in the second hybrid drive mode, the clutch CL is released as in the first hybrid drive mode. The electric power generated by the generator GEN by the power of the engine ENG and the electric power output by the battery BAT are supplied to the motor MOT and the drive wheels DW and DW are driven by the power output by the motor MOT according to the electric power, in such a manner that the vehicle travels. In the second hybrid drive mode, the electric power output from the battery BAT is also supplied to the motor MOT, so that the driving force which can be output by the vehicle is larger than that in the first hybrid drive mode.

The shift between the first hybrid drive mode and the second hybrid drive mode can be performed simply by switching whether the electric power from the battery BAT is supplied to the motor MOT. That is, the shift between the first hybrid drive mode and the second hybrid drive mode can be performed easily and quickly because the state of the clutch CL is not changed.

[Engine Drive Mode]

The engine drive mode is a traveling mode in which the vehicle mainly travels with the power output by the engine ENG.

[First Engine Drive Mode]

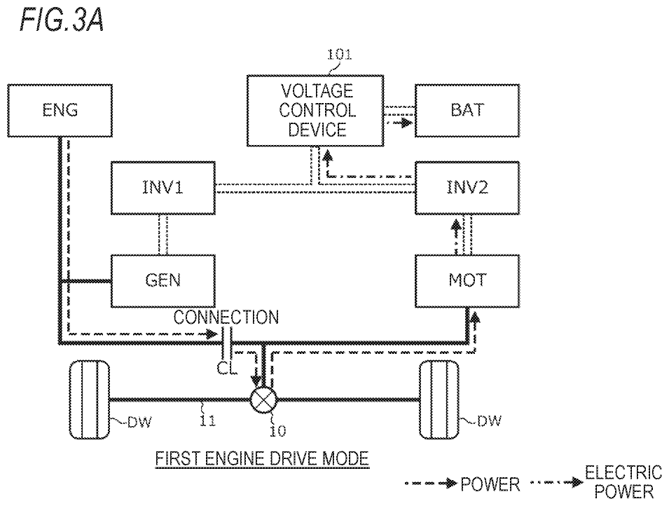

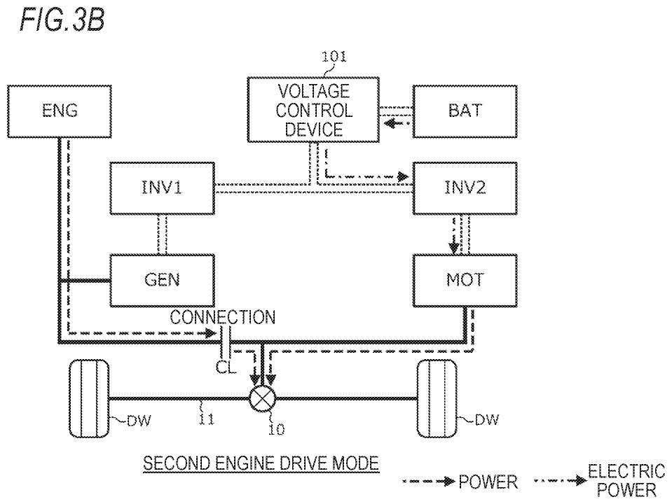

As illustrated in FIG. 3A, in the first engine drive mode, by connecting the clutch CL, the power of the engine ENG is transmitted to the drive wheels DW and DW and the power of the engine ENG drives the drive wheels DW and DW to travel the vehicle. In the first engine drive mode, the motor MOT is used only as a generator during braking of the vehicle and the electric power generated by the motor MOT is charged into the battery BAT via the second inverter INV2 and the voltage control unit 101.

[Second Engine Drive Mode]

The second engine drive mode is different from the first engine drive mode in that the electric power from the battery BAT is supplied to the motor MOT and the power output by the motor MOT according to the electric power is also transmitted to the drive wheel DW and DW. That is, as illustrated in FIG. 3B, in the second engine drive mode, similarly to the first engine drive mode, the clutch CL is connected to transmit the power of the engine ENG to the drive wheels DW and DW. The electric power output from the battery BAT is supplied to the motor MOT and the power output from the motor MOT according to the electric power is also transmitted to the drive wheels DW and DW. Thus, in the second engine drive mode, the drive wheels DW and DW are driven by the power output from the engine ENG and the power output from the motor MOT according to the electric power supplied from the battery BAT, and the vehicle travels.

The shift between the first engine drive mode and the second engine drive mode can be performed simply by switching whether the electric power from the battery BAT is supplied to the motor MOT. That is, the shift between the first engine drive mode and the second engine drive mode can be performed easily and quickly because the state of the clutch CL is not changed. On the other hand, in the shift from the hybrid drive mode to the engine drive mode, the clutch CL changes from the disconnected state to the connected state. Therefore, when shifting from the hybrid drive mode to the engine drive mode, predetermined control such as matching the rotation speed NE of the engine ENG with the rotation speed of the drive shaft 11 is required, and it takes time correspondingly, and further a temporary decrease in the driving force described below may occur.

[EV Mode]

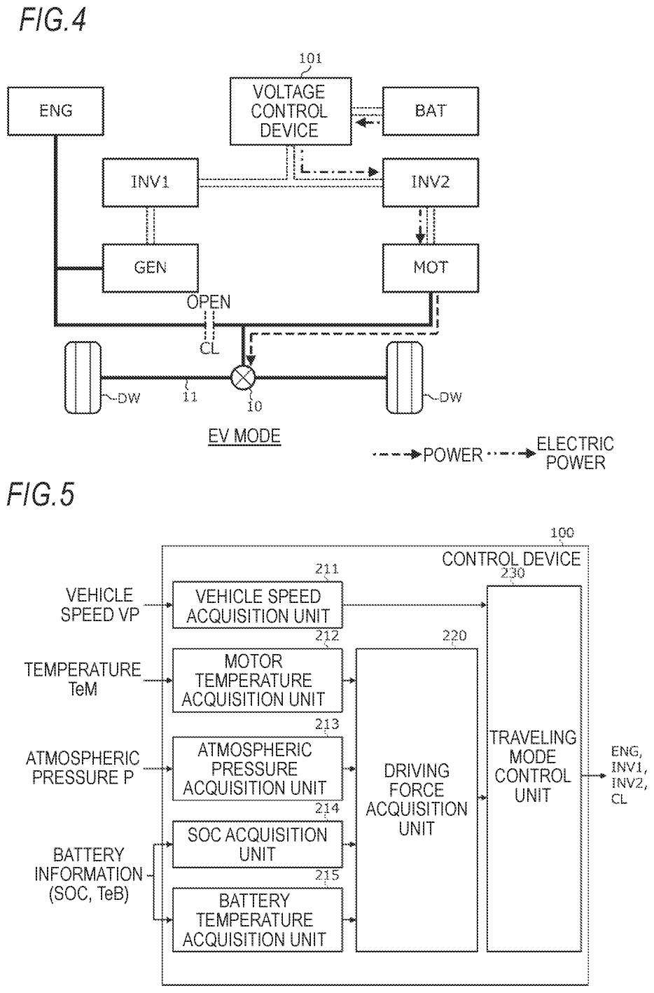

The EV mode is different from the second hybrid drive mode in that the engine ENG is stopped. That is, as illustrated in FIG. 4, in the EV mode, the engine ENG is stopped and the electric power from the battery BAT is supplied to the motor MOT, and further the drive wheels DW and DW are driven by the power output from the motor MOT according to the electric power, in such a manner that the vehicle travels.

The shift between the EV mode and the hybrid drive mode can be easily and quickly performed without changing the state of the clutch CL. On the other hand, since the clutch CL changes from the disconnected state to the connected state in the shift from the EV mode to the engine drive mode, it takes time correspondingly, and thus a temporary reduction in driving force described below may occur.

[Traveling Mode Control]

Next, control of the traveling mode of the vehicle by the control unit 100, specifically, control for traveling the vehicle in the hybrid drive mode or the engine drive mode will be described. Here, the control unit 100 basically acquires the driving force obtained in each of the second hybrid drive mode and the second engine drive mode in the current vehicle situation, and then the control unit 100 compares these, and drives the vehicle in the hybrid drive mode when a larger driving force can be obtained in the second hybrid drive mode and drives the vehicle in the engine drive mode when a larger driving force can be obtained in the second engine drive mode.

The driving force obtained in each of the second hybrid drive mode and the second engine drive mode changes depending on various factors including the vehicle speed VP. For example, the power output from the motor MOT decreases as the temperature TeM of the motor MOT increases. Therefore, when the temperature TeM is high, the driving force obtained in the second hybrid drive mode in which the power output by the motor MOT is mainly used for traveling is much more reduced than the driving force obtained in the second engine drive mode in which the power output by the engine ENG is mainly used for traveling. Therefore, the control unit 100 can efficiently maintain the driving force of the vehicle by controlling the traveling mode with reference to the temperature TeM in addition to the vehicle speed VP.

[Traveling Mode Control Based on Vehicle Speed and Motor Temperature]

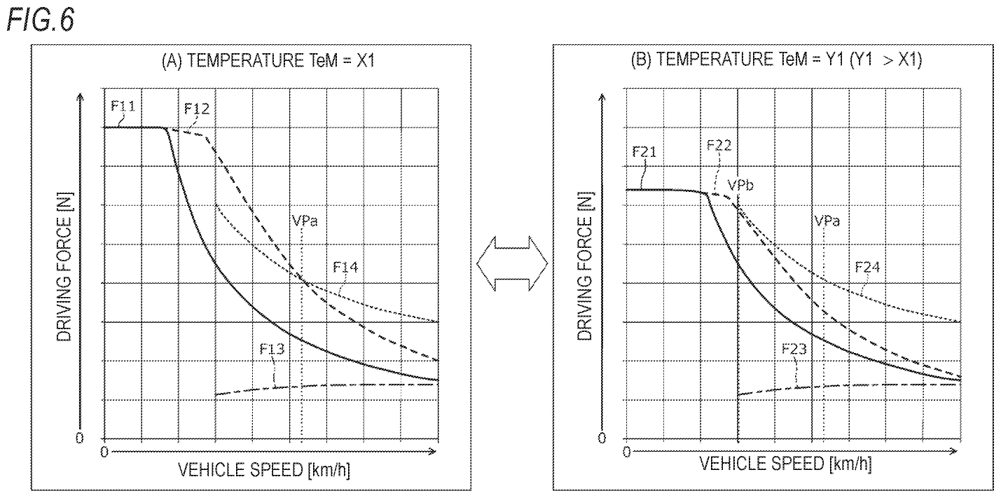

A case where the control unit 100 controls the traveling mode based on the vehicle speed VP and the temperature TeM of the motor MOT will be specifically described with reference to FIGS. 5 and 6. As illustrated in FIG. 5, here, the control unit 100 includes a vehicle speed acquisition unit 211, a motor temperature acquisition unit 212, a driving force acquisition unit 220, and a traveling mode control unit 230.

The vehicle speed acquisition unit 211 acquires the vehicle speed VP of the vehicle. The vehicle speed acquisition unit 211 can acquire the vehicle speed VP from the signal indicating the vehicle speed VP sent from the vehicle speed sensor 102 to the control unit 100. The vehicle speed sensor 102 detects, for example, the vehicle speed VP in real time and sends a signal indicating the vehicle speed VP to the control unit 100. As a result, the vehicle speed acquisition unit 211 (that is, the control unit 100) can acquire the current vehicle speed VP.

The motor temperature acquisition unit 212 acquires the temperature TeM of the motor MOT. The motor temperature acquisition unit 212 can acquire the temperature TeM from the signal indicating the temperature TeM sent from the motor temperature sensor 105 to the control unit 100. The motor temperature sensor 105 detects the temperature TeM of the motor MOT in real time and sends a signal indicating the temperature TeM to the control unit 100, for example. As a result, the motor temperature acquisition unit 212 (that is, the control unit 100) can acquire the current temperature TeM.

Then, here, the driving force acquisition unit 220 acquires the driving force (hereinafter, referred to as “driving force in the second hybrid drive mode according to the current vehicle speed VP and temperature TeM”) in the second hybrid drive mode according to the vehicle speed VP acquired by the vehicle speed acquisition unit 211 and the temperature TeM acquired by the motor temperature acquisition unit 212. By referring to the map illustrating the relationship between the vehicle speed VP, the temperature TeM, and the driving force in the second hybrid drive mode, the driving force acquisition unit 220 can acquire the driving force in the second hybrid drive mode according to the current vehicle speed VP and temperature TeM. An example of the map will be described below with reference to FIG. 6.

Here, the driving force acquisition unit 220 further acquires the driving force (hereinafter, referred to as “driving force in the second engine drive mode according to the current vehicle speed VP and temperature TeM”) in the second engine drive mode according to the vehicle speed VP acquired by the vehicle speed acquisition unit 211 and the temperature TeM acquired by the motor temperature acquisition unit 212. By referring to the map illustrating the relationship between the vehicle speed VP, the temperature TeM, and the driving force in the second engine drive mode, the driving force acquisition unit 220 can acquire the driving force in the second engine drive mode according to the current vehicle speed VP and temperature TeM. An example of the map will be described below with reference to FIG. 6.

Here, the traveling mode control unit 230 compares the driving force in the second hybrid drive mode according to the current vehicle speed VP and temperature TeM with the driving force in the second engine drive mode according to the current vehicle speed VP and temperature TeM.

As a result, when the driving force in the second hybrid drive mode corresponding to the current vehicle speed VP and temperature TeM is larger than the driving force in the second engine drive mode corresponding to the current vehicle speed VP and temperature TeM, the traveling mode control unit 230 drives the vehicle in the hybrid drive mode. Specifically, here, when the required driving force derived based on an AP opening is less than a predetermined value, the vehicle is driven in the first hybrid drive mode, and when the required driving force is more than the predetermined value, the vehicle is driven in the second hybrid drive mode.

On the other hand, when the driving force in the second engine drive mode corresponding to the current vehicle speed VP and temperature TeM is greater than the driving force in the second hybrid drive mode corresponding to the current vehicle speed VP and temperature TeM, the traveling mode control unit 230 drives the vehicle in the engine drive mode. Specifically, here, when the required driving force is less than the predetermined value, the vehicle is driven in the first engine drive mode, and when the required driving force is more than the predetermined value, the vehicle is driven in the second engine drive mode.

Section (A) of FIG. 6 illustrates an example of a map showing the driving force in each of the second hybrid drive mode and the second engine drive mode when the temperature TeM of the motor MOT is X1.

More specifically, in Section (A) of FIG. 6, a driving force F11 represents the maximum driving force corresponding to the vehicle speed VP in the first hybrid drive mode when the temperature TeM is X1. That is, the driving force F11 is the maximum driving force when the drive wheels DW and DW are driven by the power output from the motor MOT according to the electric power supplied only from the generator GEN when the temperature TeM is X.

In Section (A) of FIG. 6, a driving force F12 represents the maximum driving force according to the vehicle speed VP in the second hybrid drive mode when the temperature TeM is X1. That is, the driving force F12 is the maximum driving force when the drive wheels DW and DW are driven by the power output from the motor MOT according to the electric power supplied from the generator GEN and the battery BAT when the temperature TeM is X1. In the second hybrid drive mode, the electric power supplied from the battery BAT increases the power output by the motor MOT, so that the driving force F12 becomes larger than the driving force F11.

In Section (A) of FIG. 6, a driving force F13 represents the maximum driving force corresponding to the vehicle speed VP in the first engine drive mode when the temperature TeM is X1. That is, the driving force F13 is the maximum driving force when the drive wheels DW and DW are driven only by the power of the engine ENG when the temperature TeM is X1.

In Section (A) of FIG. 6, a driving force F14 represents the maximum driving force corresponding to the vehicle speed VP in the second engine drive mode when the temperature TeM is X1. That is, the driving force F14 is the maximum driving force when the drive wheels DW and DW are driven by the power of the engine ENG and the power output by the motor MOT according to the electric power supplied from the battery BAT when the temperature TeM is X1. In the second engine drive mode, the power output from the motor MOT by the electric power supplied from the battery BAT is also transmitted to the drive wheels DW and DW, so that the driving force F14 becomes larger than the driving force F13.

As illustrated in Section (A) of FIG. 6, when the temperature TeM is X1, the driving force F12 is larger than the driving force F14 until the vehicle speed VP becomes VPa [km/h] and the driving force F14 is larger than the driving force F12 after the vehicle speed VP exceeds VPa. Therefore, here, the traveling mode control unit 230 drives the vehicle in the hybrid drive mode until the vehicle speed VP becomes VPa and drives the vehicle in the engine drive mode after the vehicle speed VP becomes VPa. As a result, the traveling mode control unit 230 can prevent a decrease in the driving force due to the shift from the hybrid drive mode to the engine drive mode.

On the other hand, Section (B) of FIG. 6 illustrates an example of a map showing the driving force in each of the second hybrid drive mode and the second engine drive mode when the temperature TeM of the motor MOT is Y1 (Y1>X1).

More specifically, in Section (B) of FIG. 6, a driving force F21 represents the maximum driving force corresponding to the vehicle speed VP in the first hybrid drive mode when the temperature TeM is Y1. That is, the driving force F21 is the maximum driving force when the drive wheels DW and DW are driven by the power output from the motor MOT according to the electric power supplied only from the generator GEN when the temperature TeM is Y1.

In Section (B) of FIG. 6, a driving force F22 represents the maximum driving force according to the vehicle speed VP in the second hybrid drive mode when the temperature TeM is Y1. That is, the driving force F22 is the maximum driving force when the drive wheels DW and DW are driven by the power output by the motor MOT according to the electric power supplied from the generator GEN and the battery BAT when the temperature TeM is Y1. In the second hybrid drive mode, the power supplied from the battery BAT increases the power output from the motor MOT, so that the driving force F22 becomes larger than the driving force F21.

In Section (B) of FIG. 6, a driving force F23 represents the maximum driving force corresponding to the vehicle speed VP in the first engine drive mode when the temperature TeM is Y1. That is, the driving force F23 is the maximum driving force when the drive wheels DW and DW are driven only by the power of the engine ENG when the temperature TeM is Y1.

In Section (B) of FIG. 6, a driving force F24 represents the maximum driving force corresponding to the vehicle speed VP in the second engine drive mode when the temperature TeM is Y1. That is, the driving force F24 is the maximum driving force when the drive wheels DW and DW are driven by the power of the engine ENG and the power output by the motor MOT according to the electric power supplied from the battery BAT when the temperature TeM is Y1. In the second engine drive mode, the power output from the motor MOT by the electric power supplied from the battery BAT is also transmitted to the drive wheels DW and DW, so that the driving force F24 becomes larger than the driving force F23.

As illustrated in Section (B) of FIG. 6, when the temperature TeM is Y1, the driving force F22 is larger than the driving force F24 until the vehicle speed VP becomes VPb (VPb<VPa) 1 km/hl and the driving force F24 is larger than the driving force F22 after the vehicle speed VP exceeds VPb. Therefore, here, the traveling mode control unit 230 drives the vehicle in the hybrid drive mode until the vehicle speed VP becomes VPb and drives the vehicle in the engine drive mode after the vehicle speed VP becomes VPb. As a result, the traveling mode control unit 230 can prevent a decrease in the driving force due to the shift from the hybrid drive mode to the engine drive mode.

As described above, when the temperature TeM of the motor MOT becomes high, the driving force obtained in the second hybrid drive mode in which the power output by the motor MOT is mainly used for traveling is much more reduced than the driving force obtained in the second engine drive mode in which the power output by the engine ENG is mainly used for traveling. Therefore, when the temperature TeM is high, the control unit 100 makes it easier (decreases the vehicle speed VP which is the condition for shifting the mode to the engine drive mode) to shift to the engine drive mode than when the temperature TeM is low, so the driving force of the vehicle can be efficiently maintained.

[Traveling Mode Control Based on Vehicle Speed and Atmospheric Pressure]

The power output by the engine ENG decreases as the atmospheric pressure P around the vehicle decreases. Therefore, when the atmospheric pressure P is low, the driving force obtained in the second engine drive mode in which the power output by the engine ENG is mainly used for traveling is much more reduced than the driving force obtained in the second hybrid drive mode in which the power output by the motor MOT is mainly used for traveling. Therefore, the control unit 100 can efficiently maintain the driving force of the vehicle by controlling the traveling mode by referring to the atmospheric pressure P as well as the vehicle speed VP.

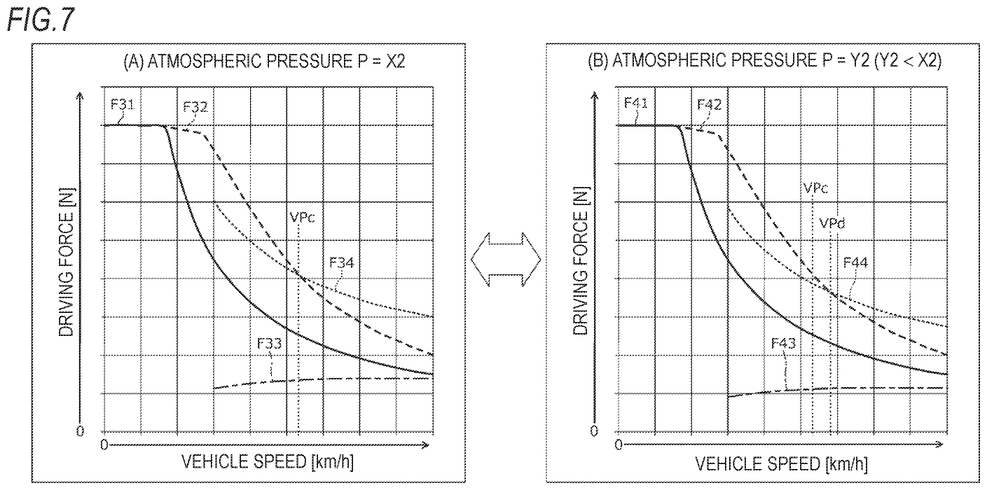

A case where the control unit 100 controls the traveling mode based on the vehicle speed VP and the atmospheric pressure P will be specifically described with reference to FIGS. 5 and 7. Here, as illustrated in FIG. 5, the control unit 100 includes the vehicle speed acquisition unit 211 described above, an atmospheric pressure acquisition unit 213 which acquires the atmospheric pressure P around the vehicle, the driving force acquisition unit 220, and the traveling mode control unit 230. The atmospheric pressure acquisition unit 213 can acquire the atmospheric pressure P from the signal indicating the atmospheric pressure P sent from the atmospheric pressure sensor 106 to the control unit 100. The atmospheric pressure sensor 106 detects, for example, the atmospheric pressure P in real time and sends a signal indicating the atmospheric pressure P to the control unit 100. Thereby, the atmospheric pressure acquisition unit 213 (that is, the control unit 100) can acquire the current atmospheric pressure P.

Then, here, the driving force acquisition unit 220 acquires the driving force (hereafter, referred to as “driving force in the second hybrid drive mode according to the current vehicle speed VP and atmospheric pressure P”) in the second hybrid drive mode according to the vehicle speed VP acquired by the vehicle speed acquisition unit 211 and the atmospheric pressure P acquired by the atmospheric pressure acquisition unit 213. By referring to the map illustrating the relationship between the vehicle speed VP, the atmospheric pressure P, and the driving force in the second hybrid drive mode, the driving force acquisition unit 220 can acquire the driving force in the second hybrid drive mode according to the current vehicle speed VP and atmospheric pressure P. An example of the map will be described below with reference to FIG. 7.

Here, the driving force acquisition unit 220 further acquires the driving force (hereafter, referred to as “driving force in the second engine drive mode according to the current vehicle speed VP and atmospheric pressure P”) in the second engine drive mode according to the vehicle speed VP acquired by the vehicle speed acquisition unit 211 and the atmospheric pressure P acquired by the atmospheric pressure acquisition unit 213. By referring to the map illustrating the relationship between the vehicle speed VP, the atmospheric pressure P, and the driving force in the second engine drive mode, the driving force acquisition unit 220 can acquire the driving force in the second engine drive mode according to the current vehicle speed VP and atmospheric pressure P. An example of the map will be described below with reference to FIG. 7.

Here, the traveling mode control unit 230 compares the driving force in the second hybrid drive mode according to the current vehicle speed VP and atmospheric pressure P with the driving force in the second engine drive mode according to the current vehicle speed VP and atmospheric pressure P.

As a result, when the driving force in the second hybrid drive mode corresponding to the current vehicle speed VP and atmospheric pressure P is larger than the driving force in the second engine drive mode corresponding to the current vehicle speed VP and atmospheric pressure P, the traveling mode control unit 230 drives the vehicle in the hybrid drive mode. Specifically, here, when the required driving force is less than a predetermined value, the vehicle is traveled in the first hybrid drive mode, and when the required driving force is more than the predetermined value, the vehicle is traveled in the second hybrid drive mode.

On the other hand, when the driving force in the second engine drive mode corresponding to the current vehicle speed VP and atmospheric pressure P is greater than the driving force in the second hybrid drive mode corresponding to the current vehicle speed VP and atmospheric pressure P, the traveling mode control unit 230 drives the vehicle in the engine drive mode. Specifically, here, when the required driving force is less than the predetermined value, the vehicle is traveled in the first engine drive mode, and when the required driving force is more than the predetermined value, the vehicle is traveled in the second engine drive mode.

Section (A) of FIG. 7A illustrates an example of the map showing the driving force in each of the second hybrid drive mode and the second engine drive mode when the atmospheric pressure P is X2.

Specifically, in Section (A) of FIG. 7, a driving force F31 represents the maximum driving force corresponding to the vehicle speed VP in the first hybrid drive mode when the atmospheric pressure P is X2. That is, the driving force F31 is the maximum driving force when the drive wheels DW and DW are driven by the power output from the motor MOT according to the electric power supplied only from the generator GEN when the atmospheric pressure P is X2.

In Section (A) of FIG. 7, a driving force F32 represents the maximum driving force corresponding to the vehicle speed VP in the second hybrid drive mode when the atmospheric pressure P is X2. That is, the driving force F32 is the maximum driving force when the drive wheels DW and DW are driven by the power output from the motor MOT according to the power supplied from the generator GEN and the battery BAT when the atmospheric pressure P is X2. In the second hybrid drive mode, the power output from the motor MOT is increased by the electric power supplied from the battery BAT, so that the driving force F32 becomes larger than the driving force F31.

In Section (A) of FIG. 7, a driving force F33 represents the maximum driving force corresponding to the vehicle speed VP in the first engine drive mode when the atmospheric pressure P is X2. That is, the driving force F33 is the maximum driving force when the drive wheels DW and DW are driven only by the power of the engine ENG when the atmospheric pressure P is X2.

In Section (A) of FIG. 7, a driving force F34 represents the maximum driving force corresponding to the vehicle speed VP in the second engine drive mode when the atmospheric pressure P is X2. That is, the driving force F34 is the maximum driving force when the drive wheels DW are DW are driven by the power of the engine ENG and the power output by the motor MOT according to the electric power supplied from the battery BAT when the atmospheric pressure P is X2. In the second engine drive mode, the power output from the motor MOT by the electric power supplied from the battery BAT is also transmitted to the drive wheels DW and DW, so that the driving force F34 becomes larger than the driving force F33.

As illustrated in Section (A) of FIG. 7, when the atmospheric pressure P is X2, the driving force F32 is larger than the driving force F34 until the vehicle speed VP becomes VPc [km/h], and the driving force F34 is larger than the driving force F32 after the vehicle speed VP exceeds VPc. Therefore, here, the traveling mode control unit 230 drives the vehicle in the hybrid drive mode until the vehicle speed VP becomes VPc and drives the vehicle in the engine drive mode after the vehicle speed VP becomes VPc. As a result, the traveling mode control unit 230 can prevent a decrease in the driving force due to the shift from the hybrid drive mode to the engine drive mode.

On the other hand. Section (B) of FIG. 7 illustrates an example of the map showing the driving force in each of the second hybrid drive mode and the second engine drive mode when the atmospheric pressure P is Y2 (Y2<X2).

More specifically, in Section (B) of FIG. 7, a driving force F41 represents the maximum driving force corresponding to the vehicle speed VP in the first hybrid drive mode when the atmospheric pressure P is Y2. That is, the driving force F41 is the maximum driving force when the drive wheels DW and DW are driven by the power output from the motor MOT according to the electric power supplied only from the generator GEN when the atmospheric pressure P is Y2.

In Section (B) of FIG. 7, a driving force F42 represents the maximum driving force corresponding to the vehicle speed VP in the second hybrid drive mode when the atmospheric pressure P is Y2. That is, the driving force F42 is the maximum driving force when the drive wheels DW and DW are driven by the power output from the motor MOT according to the electric power supplied from the generator GEN and the battery BAT when the atmospheric pressure P is Y2. In the second hybrid drive mode, the power output from the motor MOT is increased by the electric power supplied from the battery BAT, so that the driving force F42 becomes larger than the driving force F41.

In Section (B) of FIG. 7, a driving force F43 represents the maximum driving force corresponding to the vehicle speed VP in the first engine drive mode when the atmospheric pressure P is Y2. That is, the driving force F43 is the maximum driving force when the drive wheels DW and DW are driven only by the power of the engine ENG when the atmospheric pressure P is Y2.

In Section (B) of FIG. 7, a driving force F44 represents the maximum driving force according to the vehicle speed VP in the second engine drive mode when the atmospheric pressure P is Y2. That is, the driving force F44 is the maximum driving force when the drive wheels DW and DW are driven by the power of the engine ENG and the power output by the motor MOT according to the electric power supplied from the battery BAT when the atmospheric pressure P is Y2. In the second engine drive mode, the power output from the motor MOT by the electric power supplied from the battery BAT is also transmitted to the drive wheels DW and DW, so that the driving force F44 becomes larger than the driving force F43.

As illustrated in Section (B) of FIG. 7, when the atmospheric pressure P is Y2, the driving force F42 is larger than the driving force F44 until the vehicle speed VP becomes VPd (VPd>VPc) [km/h] and the driving force F44 is larger than the driving force F42 after the vehicle speed VP exceeds VPd. Therefore, here, the traveling mode control unit 230 drives the vehicle in the hybrid drive mode until the vehicle speed VP becomes VPd and drives the vehicle in the engine drive mode after the vehicle speed VP becomes VPd. As a result, the traveling mode control unit 230 can prevent a decrease in the driving force due to the shift from the hybrid drive mode to the engine drive mode.

As described above, when the atmospheric pressure P becomes low, the driving force obtained in the second engine drive mode in which the power output by the engine ENG is mainly used for traveling is much more reduced than the driving force obtained in the second hybrid drive mode in which the power output by the motor MOT is mainly used for traveling. Therefore, when the atmospheric pressure P is low, the control unit 100 makes it difficult (increases the vehicle speed VP which is the condition for shifting the mode to the engine drive mode) to shift to the engine drive mode as compared to when the atmospheric pressure P is high, so that the driving force of the vehicle can be efficiently maintained.

[Traveling Mode Control Based on Vehicle Speed and Battery Charge Status]

The output of the battery BAT decreases as the remaining capacity of the battery BAT decreases. In response, the power output from the motor MOT by the electric power from the battery BAT decreases as the remaining capacity of the battery BAT decreases. Therefore, when the remaining capacity of the battery BAT is small, the driving force obtained in the second engine drive mode in which the power is output from the motor MOT only by the electric power from the battery BAT is much more reduced than the driving force obtained in the second hybrid drive mode in which the electric power from the generator GEN is also used to output power from the motor MOT. Therefore, the control unit 100 can efficiently maintain the driving force of the vehicle by controlling the traveling mode by referring to the vehicle speed VP as well as the remaining capacity of the battery BAT.

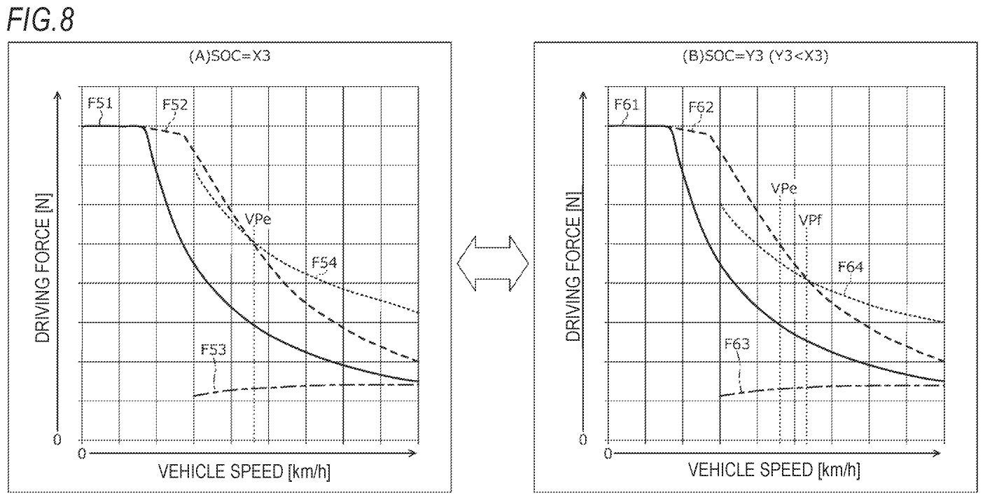

A case where the control unit 100 controls the traveling mode based on the vehicle speed VP and the charge status of the battery will be specifically described with reference to FIGS. 5 and 8. As illustrated in FIG. 5, here, the control unit 100 includes the vehicle speed acquisition unit 211 described above, an SOC acquisition unit 214 which acquires a state of charge (SOC) which is a variable that represents the state of charge (remaining capacity) of the battery BAT by percentage, the driving force acquisition unit 220, and the traveling mode control unit 230. The SOC acquisition unit 214 can acquire the SOC by calculating the SOC based on the information indicating the terminal voltage and the charge/discharge current included in the battery information sent from the battery sensor 104 to the control unit 100. When the SOC is 100%, the battery BAT is in a fully charged state.

Here, the driving force acquisition unit 220 acquires the driving force (hereinafter, referred to as “driving force in the second hybrid drive mode according to the current vehicle speed VP and SOC”) in the second hybrid drive mode according to the vehicle speed VP acquired by the vehicle speed acquisition unit 211 and the SOC acquired by the SOC acquisition unit 214. By referring to the map illustrating the relationship between the vehicle speed VP, SOC, and the driving force in the second hybrid drive mode, the driving force acquisition unit 220 can acquire the driving force in the second hybrid drive mode according to the current vehicle speed VP and SOC. An example of the map will be described below with reference to FIG. 8.

Here, the driving force acquisition unit 220 further acquires the driving force (hereinafter, referred to as “driving force in the second engine drive mode according to the current vehicle speed VP and SOC”) in the second engine drive mode corresponding to the vehicle speed VP acquired by the vehicle speed acquisition unit 211 and the SOC acquired by the SOC acquisition unit 214. By referring to the map illustrating the relationship between the vehicle speed VP, SOC, and the driving force in the second engine drive mode, the driving force acquisition unit 220 can acquire the driving force in the second engine drive mode according to the current vehicle speed VP and SOC. An example of the map will be described below with reference to FIG. 8.

Here, the traveling mode control unit 230 compares the driving force in the second hybrid drive mode according to the current vehicle speed VP and SOC with the driving force in the second engine drive mode according to the current vehicle speed VP and SOC.

As a result, when the driving force in the second hybrid drive mode corresponding to the current vehicle speed VP and SOC is greater than the driving force in the second engine drive mode corresponding to the current vehicle speed VP and SOC, the traveling mode control unit 230 drives the vehicle in the hybrid drive mode. Specifically, here, when the required driving force is less than the predetermined value, the vehicle is driven in the first hybrid drive mode, and when the required driving force is more than the predetermined value, the vehicle is driven in the second hybrid drive mode.

On the other hand, when the driving force in the second engine drive mode corresponding to the current vehicle speed VP and SOC is greater than the driving force in the second hybrid drive mode corresponding to the current vehicle speed VP and SOC, the traveling mode control unit 230 drives the vehicle in the engine drive mode. Specifically, here, when the required driving force is less than the predetermined value, the vehicle is traveled in the first engine drive mode, and when the required driving force is more than the predetermined value, the vehicle is traveled in the second engine drive mode.

Section (A) of FIG. 8 illustrates an example of a map showing the driving force in each of the second hybrid drive mode and the second engine drive mode when the SOC is X3.

Specifically, in Section (A) of FIG. 8, a driving force F51 represents the maximum driving force according to the vehicle speed VP in the first hybrid drive mode when the SOC is X3. That is, the driving force F51 is the maximum driving force when the drive wheels DW and DW are driven by the power output from the motor MOT according to the electric power supplied from only the generator GEN when the SOC is X3.

In Section (A) of FIG. 8, a driving force F52 represents the maximum driving force corresponding to the vehicle speed VP in the second hybrid drive mode when the SOC is X3. That is, the driving force F52 is the maximum driving force when the drive wheels DW and DW are driven by the power output by the motor MOT according to the electric power supplied from the generator GEN and the battery BAT when the SOC is X3. In the second hybrid drive mode, the power output from the motor MOT increases due to the electric power supplied from the battery BAT, so that the driving force F52 becomes larger than the driving force F51.

In Section (A) of FIG. 8, a driving force F53 represents the maximum driving force according to the vehicle speed VP in the first engine drive mode when the SOC is X3. That is, the driving force F53 is the maximum driving force when the drive wheels DW and DW are driven only by the power of the engine ENG when the SOC is X3.

In Section (A) of FIG. 8, a driving force F54 represents the maximum driving force corresponding to the vehicle speed VP in the second engine drive mode when the SOC is X3. That is, the driving force F54 is the maximum driving force when the drive wheels DW and DW are driven by the power of the engine ENG and the power output by the motor MOT according to the electric power supplied from the battery BAT when the SOC is X3. In the second engine drive mode, the power output from the motor MOT by the electric power supplied from the battery BAT is also transmitted to the drive wheels DW and DW, so that the driving force F54 becomes larger than the driving force F53.

As illustrated in Section (A) of FIG. 8, when the SOC is X3, the driving force F52 is larger than the driving force F54 until the vehicle speed VP becomes VPe [km/h] and the driving force F54 is larger than the driving force F52 after the vehicle speed VP exceeds VPe. Therefore, here, the traveling mode control unit 230 drives the vehicle in the hybrid drive mode until the vehicle speed VP becomes VPe and drives the vehicle in the engine drive mode after the vehicle speed VP becomes VPe. As a result, the traveling mode control unit 230 can prevent the decrease in the driving force due to the shift from the hybrid drive mode to the engine drive mode.

On the other hand, Section (B) of FIG. 8 illustrates an example of a map showing the driving force in each of the second hybrid drive mode and the second engine drive mode when the SOC is Y3 (Y3<X3).

More specifically, in Section (B) of FIG. 8, a driving force F61 represents the maximum driving force according to the vehicle speed VP in the first hybrid drive mode when the SOC is Y3. That is, the driving force F61 is the maximum driving force when the drive wheels DW and DW are driven by the power output from the motor MOT according to the electric power supplied only from the generator GEN when the SOC is Y3.

In Section (B) of FIG. 8, a driving force F62 represents the maximum driving force according to the vehicle speed VP in the second hybrid drive mode when the SOC is Y3. That is, the driving force F62 is the maximum driving force when the drive wheels DW and DW are driven by the power output from the motor MOT according to the electric power supplied from the generator GEN and the battery BAT when the SOC is Y3. In the second hybrid drive mode, the electric power supplied from the battery BAT increases the power output by the motor MOT, so that the driving force F62 becomes larger than the driving force F61.

In Section (B) of FIG. 8, a driving force F63 represents the maximum driving force corresponding to the vehicle speed VP in the first engine drive mode when the SOC is Y3. That is, the driving force F63 is the maximum driving force when the drive wheels DW and DW are driven only by the power of the engine ENG when the SOC is Y3.

In Section (B) of FIG. 8, a driving force F64 represents the maximum driving force corresponding to the vehicle speed VP in the second engine drive mode when the SOC is Y3. That is, the driving force F64 is the maximum driving force when the drive wheels DW and DW are driven by the power of the engine ENG and the power output by the motor MOT according to the electric power supplied from the battery BAT when the SOC is Y3. In the second engine drive mode, the power output from the motor MOT by the electric power supplied from the battery BAT is also transmitted to the drive wheels DW and DW, so that the driving force F64 becomes larger than the driving force F63.

As illustrated in Section (B) of FIG. 8, when the SOC is Y3, the driving force F62 is larger than the driving force F64 until the vehicle speed VP becomes VPf (VPf>VPe) [km/h] and the driving force F64 is larger than the driving force F62 after the vehicle speed VP exceeds VPf. Therefore, here, the traveling mode control unit 230 drives the vehicle in the hybrid drive mode until the vehicle speed VP becomes VPf and drives the vehicle in the engine drive mode after the vehicle speed VP becomes VPf. As a result, the traveling mode control unit 230 can prevent the decrease in the driving force due to the shift from the hybrid drive mode to the engine drive mode.

As described above, when the SOC is low, the driving force obtained in the second engine drive mode is much more reduced than the driving force obtained in the second hybrid drive mode. Therefore, when the SOC is low, the control unit 100 makes it difficult (increases the vehicle speed VP which is the condition for shifting the mode to the engine drive mode) to shift the mode to the engine drive mode as compared to when the SOC is high, so that the driving force of the vehicle can be efficiently maintained.

[Traveling Mode Control Based on Vehicle Speed and Battery Temperature]

The output of the battery BAT decreases as the temperature TeB of the battery BAT decreases. Accordingly, the power output from the motor MOT by the electric power from the battery BAT decreases as the temperature TeB of the battery BAT decreases. Therefore, when the temperature TeB of the battery BAT is low, the driving force obtained in the second engine drive mode in which the power is output from the motor MOT only by the electric power from the battery BAT is much more reduced than the driving force obtained in the second hybrid drive mode in which the electric power from the generator GEN is also used to output the power from the motor MOT. Therefore, the control unit 100 can efficiently maintain the driving force of the vehicle by controlling the traveling mode by referring to the temperature TeB of the battery BAT as well as the vehicle speed VP.

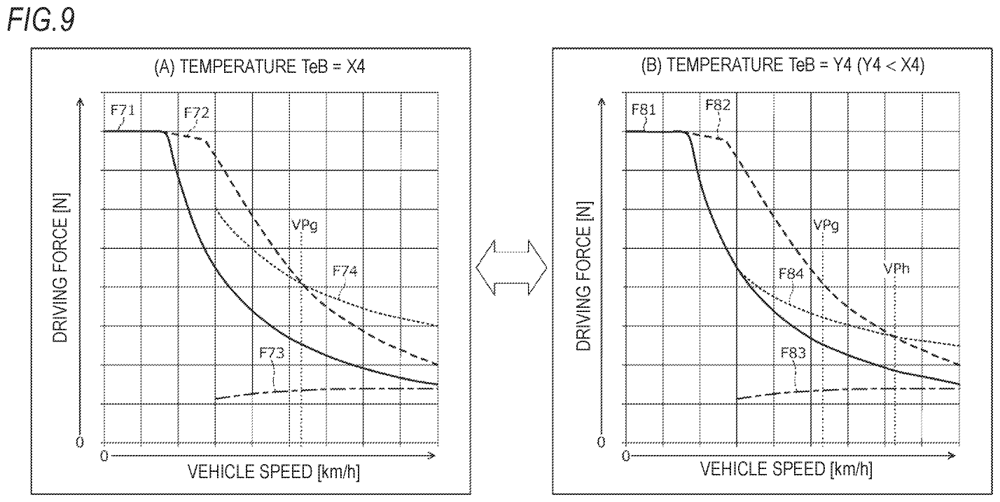

A case where the control unit 100 controls the traveling mode based on the vehicle speed VP and the temperature TeB of the battery BAT will be specifically described with reference to FIGS. 5 and 9. As illustrated in FIG. 5, here, the control unit 100 includes the vehicle speed acquisition unit 211, a battery temperature acquisition unit 215 which acquires the temperature TeB of the battery BAT, the driving force acquisition unit 220, and the traveling mode control unit 230. The battery temperature acquisition unit 215 can acquire the temperature TeB from the information indicating the temperature TeB included in the battery information sent from the battery sensor 104 to the control unit 100. The battery sensor 104 detects, for example, the temperature TeB of the battery BAT in real time and sends the battery information including the information indicating the temperature TeB to the control unit 100. Thereby, the battery temperature acquisition unit 215 (that is, the control unit 100) can acquire the current temperature TeB.

Here, the driving force acquisition unit 220 acquires the driving force (hereinafter, referred to as “driving force in the second hybrid drive mode according to the current vehicle speed VP and temperature TeB”) in the second hybrid drive mode according to the vehicle speed VP acquired by the vehicle speed acquisition unit 211 and the temperature TeB acquired by the battery temperature acquisition unit 215. By referring to the map illustrating the relationship between the vehicle speed VP, the temperature TeB, and the driving force in the second hybrid drive mode, the driving force acquisition unit 220 can acquire the driving force in the second hybrid drive mode according to the current vehicle speed VP and temperature TeB. An example of the map will be described below with reference to FIG. 9.

Here, the driving force acquisition unit 220 further acquires the driving force (hereinafter, referred to as “driving force in the second engine drive mode according to the current vehicle speed VP and temperature TeB”) in the second engine drive mode corresponding to the vehicle speed VP acquired by the vehicle speed acquisition unit 211 and the temperature TeB acquired by the battery temperature acquisition unit 215. By referring to the map illustrating the relationship between the vehicle speed VP, the temperature TeB, and the driving force in the second engine drive mode, the driving force acquisition unit 220 can acquire the driving force in the second engine drive mode according to the current vehicle speed VP and temperature TeB. An example of the map will be described below with reference to FIG. 9.

Here, the traveling mode control unit 230 compares the driving force in the second hybrid drive mode corresponding to the current vehicle speed VP and temperature TeB with the driving force in the second engine drive mode corresponding to the current vehicle speed VP and temperature TeB.

As a result, when the driving force in the second hybrid drive mode corresponding to the current vehicle speed VP and temperature TeB is greater than the driving force in the second engine drive mode corresponding to the current vehicle speed VP and temperature TeB, the traveling mode control unit 230 drives the vehicle in the hybrid drive mode. Specifically, here, when the required driving force is less than the predetermined value, the vehicle is traveled in the first hybrid drive mode, and when the required driving force is more than the predetermined value, the vehicle is traveled in the second hybrid drive mode.

On the other hand, when the driving force in the second engine drive mode corresponding to the current vehicle speed VP and temperature TeB is greater than the driving force in the second hybrid drive mode corresponding to the current vehicle speed VP and temperature TeB, the traveling mode control unit 230 drives the vehicle in the engine drive mode. Specifically, here, when the required driving force is less than the predetermined value, the vehicle is traveled in the first engine drive mode, and when the required driving force is more than the predetermined value, the vehicle is traveled in the second engine drive mode.

Section (A) of FIG. 9 illustrates an example of a map showing the driving force in each of the second hybrid drive mode and the second engine drive mode when the temperature TeB is X4.

More specifically, in Section (A) of FIG. 9, a driving force F71 represents the maximum driving force corresponding to the vehicle speed VP in the first hybrid drive mode when the temperature TeB is X4. That is, the driving force F71 is the maximum driving force when the drive wheels DW and DW are driven by the power output from the motor MOT according to the electric power supplied only from the generator GEN when the temperature TeB is X4.

In Section (A) of FIG. 9, a driving force F72 represents the maximum driving force according to the vehicle speed VP in the second hybrid drive mode when the temperature TeB is X4. That is, the driving force F72 is the maximum driving force when the drive wheels DW and DW are driven by the power output from the motor MOT according to the electric power supplied from the generator GEN and the battery BAT when the temperature TeB is X4. In the second hybrid drive mode, the electric power supplied from the battery BAT increases the power output by the motor MOT, so that the driving force F72 becomes larger than the driving force F71.

In Section (A) of FIG. 9, a driving force F73 represents the maximum driving force according to the vehicle speed VP in the first engine drive mode when the temperature TeB is X4. That is, the driving force F73 is the maximum driving force when the drive wheels DW and DW are driven only by the power of the engine ENG when the temperature TeB is X4.

In Section (A) of FIG. 9, a driving force F74 represents the maximum driving force corresponding to the vehicle speed VP in the second engine drive mode when the temperature TeB is X4. That is, the driving force F74 is the maximum driving force when the drive wheels DW and DW are driven by the power of the engine ENG and the power output by the motor MOT according to the electric power supplied from the battery BAT when the temperature TeB is X4. In the second engine drive mode, the power output from the motor MOT by the electric power supplied from the battery BAT is also transmitted to the drive wheel DW and DW, so that the driving force F74 becomes larger than the driving force F73.

As illustrated in Section (A) of FIG. 9, when the temperature TeB is X4, the driving force F72 is larger than the driving force F74 until the vehicle speed VP becomes VPg [km/h] and the driving force F74 is larger than the driving force F72 after the vehicle speed VP exceeds VPg. Therefore, here, the traveling mode control unit 230 drives the vehicle in the hybrid drive mode until the vehicle speed VP becomes VPg and drives the vehicle in the engine drive mode after the vehicle speed VP becomes VPg. As a result, the traveling mode control unit 230 can prevent the decrease in the driving force due to the shift from the hybrid drive mode to the engine drive mode.

On the other hand, Section (B) of FIG. 9 illustrates an example of a map showing the driving force in each of the second hybrid drive mode and the second engine drive mode when the temperature TeB is Y4 (Y4<X4).

More specifically, in Section (B) of FIG. 9, a driving force F81 represents the maximum driving force corresponding to the vehicle speed VP in the first hybrid drive mode when the temperature TeB is Y4. That is, the driving force F81 is the maximum driving force when the drive wheels DW and DW are driven by the power output from the motor MOT according to the electric power supplied only from the generator GEN when the temperature TeB is Y4.

In Section (B) of FIG. 9, a driving force F82 represents the maximum driving force corresponding to the vehicle speed VP in the second hybrid drive mode when the temperature TeB is Y4. That is, the driving force F82 is the maximum driving force when the drive wheels DW and DW are driven by the power output from the motor MOT according to the electric power supplied from the generator GEN and the battery BAT when the temperature TeB is Y4. In the second hybrid drive mode, the power output from the motor MOT is increased by the electric power supplied from the battery BAT, so that the driving force F82 becomes larger than the driving force F81.

In Section (B) of FIG. 9, a driving force F83 represents the maximum driving force corresponding to the vehicle speed VP in the first engine drive mode when the temperature TeB is Y4. That is, the driving force F83 is the maximum driving force when the drive wheels DW and DW are driven only by the power of the engine ENG when the temperature TeB is Y4.

In Section (B) of FIG. 9, a driving force F84 represents the maximum driving force according to the vehicle speed VP in the second engine drive mode when the temperature TeB is Y4. That is, the driving force F84 is the maximum driving force when the drive wheels DW and DW are driven by the power of the engine ENG and the power output by the motor MOT according to the electric power supplied from the battery BAT when the temperature TeB is Y4. In the second engine drive mode, the power output from the motor MOT by the electric power supplied from the battery BAT is also transmitted to the drive wheel DW and DW, so that the driving force F84 becomes larger than the driving force F83.

As illustrated in Section (B) of FIG. 9, when the temperature TeB is Y4, the driving force F82 is larger than the driving force F84 until the vehicle speed VP becomes VPh (VPh>VPg) [km/h] and the driving force F84 is larger than the driving force F82 after the vehicle speed VP exceeds VPh. Therefore, here, the traveling mode control unit 230 drives the vehicle in the hybrid drive mode until the vehicle speed VP becomes VPh and drives the vehicle in the engine drive mode after the vehicle speed VP becomes VPh. As a result, the traveling mode control unit 230 can prevent the decrease in the driving force due to the shift from the hybrid drive mode to the engine drive mode.

As described above, when the temperature TeB of the battery BAT becomes low, the driving force obtained in the second engine drive mode in which the power is output from the motor MOT only by the electric power output from the battery BAT is much more reduced than the driving force obtained in the second hybrid drive mode in which the power output from the generator GEN is also used to output the power from the motor MOT. Therefore, when the temperature TeB is low, the control unit 100 makes it difficult (increases the vehicle speed VP which is the condition for shifting the mode to the engine drive mode) to shift to the engine drive mode as compared to when the temperature TeB is high, so that the driving force of the vehicle can be efficiently maintained.

The control unit 100 is realized by, for example, an electric control unit (ECU) including a processor, a memory, an interface, and the like. Each functional unit of the control unit 100 described above can realize its function, for example, by the processor of the ECU executing a program stored in the memory or by the interface of the ECU. Each map described above is stored in advance in the memory of the control unit 100 by the manufacturer of the vehicle or the control unit 100, for example. Each map described above may be stored outside the control unit 100. Here, the control unit 100 acquires the map from the outside through the interface or the like as necessary.

[Prohibition and Permission to Shift to Engine Drive Mode]

Next, the prohibition and permission of the shift to the engine drive mode by the control unit 100 will be described. As described above, when the maximum driving force in the second engine drive mode according to the vehicle speed VP or the like becomes larger than the maximum driving force in the second hybrid drive mode according to the vehicle speed VP or the like, the control unit 100 shifts the mode from the hybrid drive mode to the engine drive mode.

Hereinafter, the maximum driving force in the second engine drive mode according to the vehicle speed VP or the like is also simply referred to as “maximum driving force in the engine drive mode”. Similarly, the maximum driving force in the second hybrid drive mode according to the vehicle speed VP or the like is also simply referred to as “maximum driving force in the hybrid drive mode”.

Depending on the required driving force of the vehicle when the maximum driving force in the engine drive mode becomes larger than the maximum driving force in the hybrid drive mode, with the shift from the hybrid drive mode to the engine drive mode, a sudden change (hereinafter referred to as “stepwise change in driving force”) in the driving force output by the vehicle may occur. When a stepwise change in the driving force occurs, the driver may feel uncomfortable and the quality of the vehicle may be deteriorated.

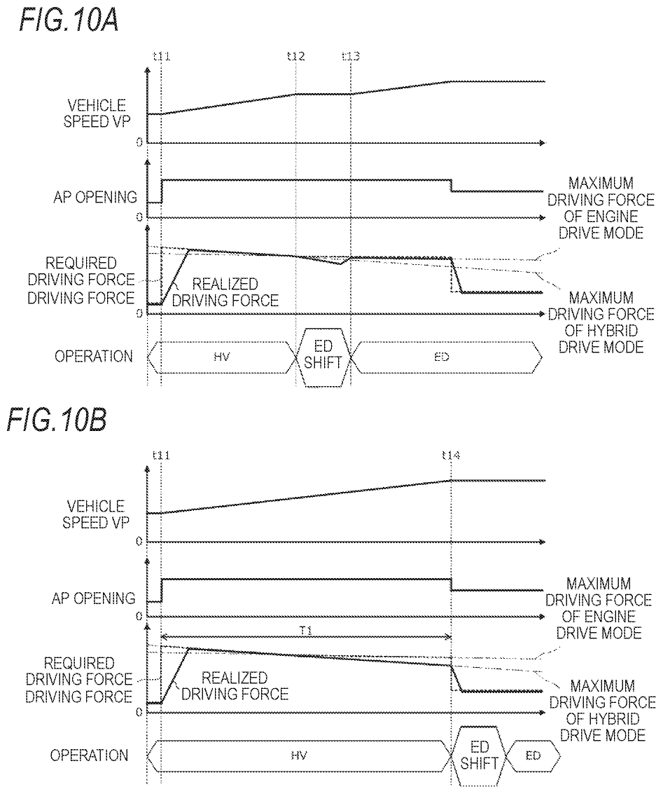

Here, with reference to FIG. 10A, a case will be described in which a stepwise change in the driving force occurs with the shift from the hybrid drive mode to the engine drive mode. As illustrated in FIG. 10A, at a time t11 when the vehicle is traveling in the hybrid drive mode (shown as operation “HV”), the driver presses the accelerator pedal to accelerate the vehicle and the AP opening and the required driving force of the vehicle are increased by operating the accelerator pedal. As illustrated in FIG. 10A, the required driving force after the increase is, for example, the maximum driving force in the hybrid drive mode. From the time t11, the driving force (shown as “realized driving force”) output by the vehicle also increases toward the maximum driving force in the hybrid drive mode according to the increase in the required driving force and the vehicle speed VP also rises as the driving force increases.

It is assumed that the maximum driving force in the engine drive mode becomes larger than the maximum driving force in the hybrid drive mode at a time t12 after the time t11. Along with this, it is assumed that the required driving force becomes the maximum driving force in the engine drive mode. It is assumed that the mode is shifted (shown as operation “ED shift”) to the engine drive mode. Here, from the time t12 to a time t13 when the shift to the engine drive mode is completed, the driving force output by the vehicle is temporarily reduced due to the control accompanying the shift to the engine drive mode.

Specifically, in order to connect the clutch CL smoothly without causing any discomfort to the driver, when shifting to the engine drive mode, predetermined control associated with the shift to the engine drive mode is performed, such as matching the rotation speed NE of the engine ENG with the rotation speed of the drive shaft 11. Due to such control accompanying the shift to the engine drive mode, the driving force of the vehicle temporarily decreases during the shift to the engine drive mode.

At the time t13, when the shift to the engine drive mode is completed and the maximum driving force in the engine drive mode can be output, the vehicle increases the output driving force to approach the required driving force. As illustrated in FIG. 10A, when the required driving force and the maximum driving force in the engine drive mode have the same magnitude, the vehicle increases the driving force to be output to the maximum driving force in the engine drive mode.

Therefore, in the case of the example illustrated in FIG. 10A, the transition in the magnitude of the driving force output by the vehicle before and after shifting to the engine drive mode is the maximum driving force (immediately before the start of the shift to the engine drive mode) of the hybrid drive mode, the driving force (shifting to the engine drive mode) temporarily decreased due to the shift to the engine drive mode, and the maximum driving force (after completing the shift to the engine drive mode) of the engine drive mode. Due to the transition in the magnitude of the driving force output by the vehicle, in the case of the example illustrated in FIG. 10A, although the AP opening is constant from the time t11, the driving force stepwise change occurs with the shift to the engine drive mode.

Therefore, the control unit 100 prevents the stepwise change in the driving force by prohibiting the shift to the engine drive mode when the required driving force of the vehicle is larger than the maximum driving force in the hybrid drive mode.

More specifically, as illustrated in FIG. 1B, the control unit 100 sets a period T1 in which the required driving force of the vehicle is larger than the maximum driving force in the hybrid drive mode, as a prohibition period for shifting to the engine drive mode. Then, the control unit 100 does not make the mode shift to the engine drive mode during the prohibition period even when the maximum driving force in the engine drive mode is larger than the maximum driving force in the hybrid drive mode.

As a result, the control unit 100 prevents the shift to the engine drive mode during a period in which the required driving force of the vehicle is larger than the maximum driving force in the hybrid drive mode, in such a manner that the control unit 100 can prevent the driving force stepwise change from occurring due to the shift to the engine drive mode during the period. Therefore, the control unit 100 can prevent the deterioration of the quality of the vehicle due to the occurrence of the stepwise change in the driving force.

When the shift to the engine drive mode is prohibited as described above, as illustrated at a time t14, the control unit 100 permits the shift to the engine drive mode and shifts the mode to the engine drive mode when the required driving force of the vehicle becomes equal to or less than the maximum driving force of the hybrid drive mode. As a result, the control unit 100 can shift the mode to the engine drive mode while preventing the occurrence of the driving force stepwise change. The time 14 is, for example, a time at which the driver returns the accelerator pedal from the position for accelerating the vehicle to the position for maintaining the vehicle speed because the vehicle speed reaches the desired vehicle speed.

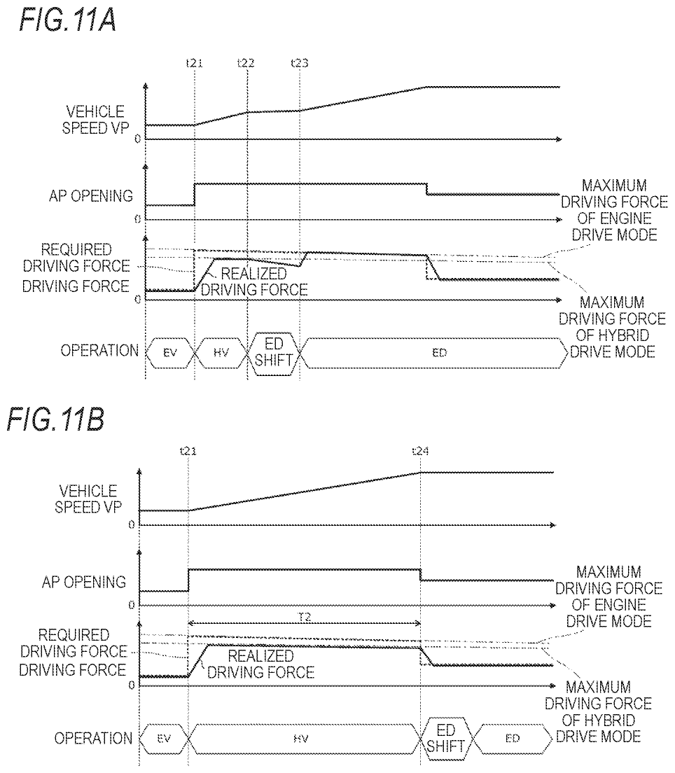

Next, another example of the case where the shift from the hybrid drive mode to the engine drive mode is prohibited will be described with reference to FIGS. 11A and 11B. First, with reference to FIG. 11A, another example of the case where a stepwise change in the driving force occurs with the transition from the hybrid drive mode to the engine drive mode will be described.

At a time t21 illustrated in FIG. 11A, the vehicle is traveling in the EV mode (illustrated as operation “EV”). As illustrated at the time t21, the control unit 100 may drive the vehicle in the EV mode or the hybrid drive mode based on the situation (for example, the remaining amount of the fuel and SOC) of the vehicle even when the maximum driving force in the engine drive mode is larger than the maximum driving force in the hybrid drive mode.

Then, at the time t21, it is assumed that the driver presses the accelerator pedal to accelerate the vehicle and the AP opening and the required driving force of the vehicle are increased by the operation of the accelerator pedal. As illustrated in FIG. 11A, it is assumed here that the increased required driving force is larger than the maximum driving force in the hybrid drive mode.

Here, the control unit 100 first shifts the drive mode to the hybrid drive mode (for example, the second hybrid drive mode) capable of outputting a driving force larger than that in the EV mode, according to the increase in the required driving force. The shift from the EV mode to the hybrid drive mode can be easily performed because the state of the clutch CL is not changed.

Therefore, from the time t21, the driving force (shown as “realized driving force”) output by the vehicle also increases toward the maximum driving force in the hybrid drive mode and the vehicle speed VP also increases according to the increase in the driving force. However, in the case of the example illustrated in FIG. 11A, since the maximum driving force in the hybrid drive mode is smaller than the required driving force, the driving force output by the vehicle cannot be increased to the required driving force in the hybrid drive mode.

Therefore, as illustrated in FIG. 11A, at a time t22 after the time 121, it is assumed that the shift (shown as operation “ED shift”) to the engine drive mode is performed in order to output a larger driving force. Here, from the time t22 to a time t23 when the shift to the engine drive mode is completed, the driving force output by the vehicle is temporarily reduced due to the control accompanying the shift to the engine drive mode.

Then, at the time t23, when the shift to the engine drive mode is completed and the maximum driving force in the engine drive mode can be output, the vehicle increases the output driving force to approach the required driving force. As illustrated in FIG. 11A, when the required driving force and the maximum driving force in the engine drive mode have the same magnitude, the vehicle increases the output driving force to the maximum driving force in the engine drive mode.

Therefore, also in the case of the example illustrated in FIG. 11A, although the AP opening is constant from the time t21, the driving force stepwise change occurs with the shift to the engine drive mode. Then, in the case of the example illustrated in FIG. 11A, since the difference between the driving force of the vehicle when shifting to the engine drive mode and the maximum driving force in the engine drive mode is larger than that in the example illustrated in FIG. 10A, a larger driving force stepwise change will occur.

Therefore, here, the control unit 100 prohibits the shift to the engine drive mode when the required driving force of the vehicle is larger than the maximum driving force in the hybrid drive mode. More specifically, as illustrated in FIG. 11B, the control unit 100 sets a period T2 in which the required driving force of the vehicle is larger than the maximum driving force in the hybrid drive mode as a prohibition period for shifting to the engine drive mode. Then, the control unit 100 does not shift the mode to the engine drive mode during this prohibition period even when the maximum driving force in the engine drive mode is larger than the maximum driving force in the hybrid drive mode.

Then, in the case of the example illustrated in FIG. 11B, after the time t21, the control unit 100 drives the vehicle in the hybrid drive mode until the time t24 when the required driving force of the vehicle becomes equal to or less than the maximum driving force of the hybrid drive mode. Then, at a time t24, the shift to the engine drive mode is permitted and the shift is made to the engine drive mode. The time t24 is, for example, a time when the driver returns the accelerator pedal from a position for accelerating the vehicle to a position for maintaining the vehicle speed because the vehicle speed reaches a desired vehicle speed.

Although the embodiment of the present invention has been described above, the present invention is not limited to the above embodiments, and various modifications and improvements can be made as appropriate.

For example, the map of the above embodiment represents the relationship between the vehicle speed VP, the driving force (maximum driving force), and another one parameter (temperature TeM, atmospheric pressure P, SOC, or temperature TeB) in the second hybrid drive mode and the second engine drive mode. However, it is not limited thereto. For example, the map may represent only the relationship between the vehicle speed VP and the driving force in the second hybrid drive mode and the second engine drive mode. The map may represent the relationship between the vehicle speed VP, the driving force, and two or more other parameters (for example, SOC and temperature TeB of battery BAT) in the second hybrid drive mode and the second engine drive mode.

In the embodiment described above, the driving force in the second hybrid drive mode and the second engine drive mode according to the current vehicle speed or the like is acquired by referring to the map, but the present invention is not limited thereto. For example, instead of the map, the relational expression representing the relation between the vehicle speed VP the driving force, and the other parameters in the second hybrid drive mode and the second engine drive mode may be stored in the control unit 100 in advance and the control unit 100 may derive the driving force in the second hybrid drive mode and the second engine drive mode according to the current vehicle speed and the like using the relational expression.

At least the following matters are described in the present specification. The components and the like corresponding to those in the embodiment described above are shown in parentheses, but the present invention is not limited to this.

(1) A control unit (control unit 100) of a vehicle which includes an internal combustion engine (engine ENG), a generator (generator GEN) which generates electric power by power of the internal combustion engine, an electric storage device (battery BAT) which stores the electric power generated by the generator, an electric motor (motor MOT) which outputs power according to the electric power supplied from the generator or the electric storage device and drives a drive wheel (drive wheel DW), and a connecting-disconnecting portion (clutch CL) for connecting/disconnecting a power transmission path between the internal combustion engine and the drive wheel and which can travel in a plurality of traveling mode including a first traveling mode (second hybrid drive mode) in which the connecting-disconnecting portion is disconnected and the drive wheel is driven by the power output from the electric motor according to the electric power supplied from the generator and the electric storage device and a second traveling mode (second engine drive mode) in which the connecting-disconnecting portion is connected and the drive wheel is driven by the power output from the internal combustion engine and the power output from the electric motor according to the electric power supplied from the electric storage device, the control unit including:

a vehicle speed acquisition unit (vehicle speed acquisition unit 211) which acquires a vehicle speed of the vehicle;

a driving force acquisition unit (driving force acquisition unit 220) which acquires a driving force in the first traveling mode according to the vehicle speed and a driving force in the second traveling mode according to the vehicle speed; and

a traveling mode control unit (traveling mode control unit 230) for driving the vehicle in the traveling mode capable of obtaining a large driving force at the vehicle speed based on a comparison result of the driving force in the first traveling mode according to the vehicle speed and the driving force in the second traveling mode according to the vehicle speed.

According to (1), the vehicle is driven in the traveling mode in which a large driving force can be obtained based on the comparison result of the driving forces of the first traveling mode and the second traveling mode according to the actual vehicle speed of the vehicle. Therefore, even when the magnitude relationship of the driving forces between the first traveling mode and the second traveling mode corresponding to a certain vehicle speed changes due to some factor, it is possible to drive the vehicle in an appropriate traveling mode, and thus it is possible to prevent a decrease in the driving force of the vehicle.

(2) The control unit of the vehicle according to (1), including:

an electric motor temperature acquisition unit (motor temperature acquisition unit 212) for acquiring a temperature of the electric motor, where

the driving force acquisition unit acquires the driving force in the first traveling mode according to the vehicle speed and the temperature of the electric motor and the driving force in the second traveling mode according to the vehicle speed and the temperature of the electric motor, and

the traveling mode control unit drives the vehicle in the traveling mode in which a large driving force can be obtained at the vehicle speed based on a comparison result of the driving force in the first traveling mode according to the vehicle speed and the temperature of the electric motor and the driving force in the second traveling mode according to the vehicle speed and the temperature of the electric motor.

According to (2), the vehicle is driven in the traveling mode in which a large driving force can be obtained based on the comparison result of the driving forces between the first traveling mode and the second traveling mode according to the actual vehicle speed of the vehicle and the temperature of the electric motor. Therefore, even when the magnitude relationship of the driving force between the first traveling mode and the second traveling mode corresponding to a certain vehicle speed changes depending on the temperature of the electric motor, it is possible to drive the vehicle in an appropriate traveling mode, and thus it is possible to prevent a decrease in the driving force of the vehicle.

(3) The control unit of the vehicle according to (1), including:

an atmospheric pressure acquisition unit (atmospheric pressure acquisition unit 213) for acquiring atmospheric pressure around the vehicle, where

the driving force acquisition unit acquires the driving force in the first traveling mode according to the vehicle speed and the atmospheric pressure and the driving force in the second traveling mode according to the vehicle speed and the atmospheric pressure, and

the traveling mode control unit drives the vehicle in the traveling mode in which a large driving force can be obtained at the vehicle speed based on a comparison result of the driving force in the first traveling mode according to the vehicle speed and the atmospheric pressure and the driving force in the second traveling mode according to the vehicle speed and the atmospheric pressure.

According to (3), the vehicle is driven in the traveling mode in which a large driving force can be obtained based on the comparison result of the driving forces in the first traveling mode and the second traveling mode according to the actual vehicle speed of the vehicle and the atmospheric pressure. Therefore, even when the magnitude relationship of the driving forces between the first traveling mode and the second traveling mode corresponding to a certain vehicle speed changes depending on the atmospheric pressure, it is possible to drive the vehicle in an appropriate traveling mode, and thus it is possible to prevent a decrease in the driving force of the vehicle.

(4) The control unit of the vehicle according to (1), including:

an electricity storage amount acquisition unit (SOC acquisition unit 214) for acquiring an electricity storage amount of the electric storage device, where

the driving force acquisition unit acquires the driving force in the first traveling mode according to the vehicle speed and the electricity storage amount and the driving force in the second traveling mode according to the vehicle speed and the electricity storage amount, and

the traveling mode control unit drives the vehicle in the traveling mode in which a large driving force can be obtained at the vehicle speed based on a comparison result between the driving force in the first traveling mode according to the vehicle speed and the electricity storage amount and the driving force in the second traveling mode according to the vehicle speed and the electricity storage amount.

According to (4), the vehicle is driven in the driving mode in which a large driving force can be obtained based on the comparison result of the driving forces between the first traveling mode and the second traveling mode according to the actual vehicle speed of the vehicle and the electricity storage amount in the electric storage device. Therefore, even when the magnitude relationship of the driving forces between the first traveling mode and the second traveling mode corresponding to a certain vehicle speed changes depending on the electricity storage amount in the electric storage device, it is possible to drive the vehicle in an appropriate traveling mode, and thus it is possible to prevent a decrease in the driving force of the vehicle.

(5) The control unit of the vehicle according to (1), including:

an electric storage device temperature acquisition unit (battery temperature acquisition unit 215) for acquiring a temperature of the electric storage device, where

the driving force acquisition unit acquires the driving force in the first traveling mode according to the vehicle speed and the temperature of the electric storage device and the driving force in the second traveling mode according to the vehicle speed and the temperature of the electric storage device, and

the traveling mode control unit drives the vehicle in the traveling mode in which a large driving force can be obtained at the vehicle speed based on a comparison result of the driving force in the first traveling mode according to the vehicle speed and the temperature of the electric storage device and the driving force in the second traveling mode according to the vehicle speed and the temperature of the electric storage device.

According to (5), the vehicle is driven in the traveling mode in which a large driving force can be obtained based on the comparison result of the driving forces between the first traveling mode and the second traveling mode according to the actual vehicle speed of the vehicle and the temperature of the electric storage device. Therefore, even when the magnitude relationship of the driving forces between the first traveling mode and the second traveling mode corresponding to a certain vehicle speed changes depending on the temperature of the electric storage device, it is possible to drive the vehicle in an appropriate traveling mode, and thus it is possible to prevent a decrease in the driving force of the vehicle.

(6) The control unit of the vehicle according to any one of (1) to (5), where

the traveling mode control unit prohibits shift from the first traveling mode to the second traveling mode in a period in which a required driving force of the vehicle according to an accelerator pedal opening in the vehicle is larger than the driving force in the first traveling mode according to the vehicle speed.

According to (6), the shift from the first traveling mode to the second traveling mode is prohibited in the period in which the required driving force is larger than the driving force in the first traveling mode corresponding to the vehicle speed. Therefore, it is possible to prevent a sudden change in the driving force of the vehicle during the period.

(7) The control unit of the vehicle according to (6), where

the traveling mode control unit permits the shift from the first traveling mode to the second traveling mode when the required driving force of the vehicle is smaller than the driving force in the first traveling mode according to the vehicle speed.

According to (7), when the required driving force becomes smaller than the driving force in the first traveling mode corresponding to the vehicle speed, the shift from the first traveling mode to the second traveling mode is permitted. Therefore, it is possible to shift the mode to the second traveling mode while preventing a sudden change in the driving force of the vehicle.

1. A control unit of a vehicle, which includes: an internal combustion engine; a generator configured to generate electric power by power of the internal combustion engine; an electric storage device configured to store the electric power generated by the generator; an electric motor configured to output power according to the electric power supplied from the generator or the electric storage device and drive a drive wheel; and a connecting-disconnecting portion configured to connect and disconnect a power transmission path between the internal combustion engine and the drive wheel, and which is configure to travel in a plurality of traveling mode including: a first traveling mode in which the connecting-disconnecting portion is disconnected and the drive wheel is driven by the power output from the electric motor according to the electric power supplied from the generator and the electric storage device; and a second traveling mode in which the connecting-disconnecting portion is connected and the drive wheel is driven by the power output from the internal combustion engine and the power output from the electric motor according to the electric power supplied from the electric storage device, the control unit comprising:
a vehicle speed acquisition unit configured to acquire a vehicle speed of the vehicle;
a driving force acquisition unit configured to acquire a driving force in the first traveling mode according to the vehicle speed and a driving force in the second traveling mode according to the vehicle speed; and
a traveling mode control unit configured to drive the vehicle in the traveling mode capable of obtaining a large driving force at the vehicle speed based on a comparison result of the driving force in the first traveling mode according to the vehicle speed and the driving force in the second traveling mode according to the vehicle speed.

2. The control unit of the vehicle according to claim 1, further comprising
an electric motor temperature acquisition unit configured to acquire a temperature of the electric motor, wherein:
the driving force acquisition unit acquires the driving force in the first traveling mode according to the vehicle speed and the temperature of the electric motor and the driving force in the second traveling mode according to the vehicle speed and the temperature of the electric motor; and
the traveling mode control unit drives the vehicle in the traveling mode in which a large driving force can be obtained at the vehicle speed based on a comparison result of the driving force in the first traveling mode according to the vehicle speed and the temperature of the electric motor and the driving force in the second traveling mode according to the vehicle speed and the temperature of the electric motor.

3. The control unit of the vehicle according to claim 1, further comprising
an atmospheric pressure acquisition unit configured to acquire atmospheric pressure around the vehicle, wherein:
the driving force acquisition unit acquires the driving force in the first traveling mode according to the vehicle speed and the atmospheric pressure and the driving force in the second traveling mode according to the vehicle speed and the atmospheric pressure; and
the traveling mode control unit drives the vehicle in the traveling mode in which a large driving force can be obtained at the vehicle speed based on a comparison result of the driving force in the first traveling mode according to the vehicle speed and the atmospheric pressure and the driving force in the second traveling mode according to the vehicle speed and the atmospheric pressure.

4. The control unit of the vehicle according to claim 1, further comprising
an electricity storage amount acquisition unit configured to acquire an electricity storage amount of the electric storage device, wherein:
the driving force acquisition unit acquires the driving force in the first traveling mode according to the vehicle speed and the electricity storage amount and the driving force in the second traveling mode according to the vehicle speed and the electricity storage amount; and
the traveling mode control unit drives the vehicle in the traveling mode in which a large driving force can be obtained at the vehicle speed based on a comparison result between the driving force in the first traveling mode according to the vehicle speed and the electricity storage amount and the driving force in the second traveling mode according to the vehicle speed and the electricity storage amount.

5. The control unit of the vehicle according to claim 1, further comprising
an electric storage device temperature acquisition unit configured to acquire a temperature of the electric storage device, wherein:
the driving force acquisition unit acquires the driving force in the first traveling mode according to the vehicle speed and the temperature of the electric storage device and the driving force in the second traveling mode according to the vehicle speed and the temperature of the electric storage device; and
the traveling mode control unit drives the vehicle in the traveling mode in which a large driving force can be obtained at the vehicle speed based on a comparison result of the driving force in the first traveling mode according to the vehicle speed and the temperature of the electric storage device and the driving force in the second traveling mode according to the vehicle speed and the temperature of the electric storage device.

6. The control unit of the vehicle according to claim 1, wherein
the traveling mode control unit prohibits shift from the first traveling mode to the second traveling mode in a period in which a required driving force of the vehicle according to an accelerator pedal opening in the vehicle is larger than the driving force in the first traveling mode according to the vehicle speed.

7. The control unit of the vehicle according to claim 6, wherein
the traveling mode control unit permits the shift from the first traveling mode to the second traveling mode when the required driving force of the vehicle is smaller than the driving force in the first traveling mode according to the vehicle speed.
